(19) United States
(12) Patent Application Publication
(10) Pub. No.: US 2015/0123878 A1
(43) Pub. Date: May 7, 2015

(54) INFORMATION DISPLAY DEVICE

(71) Applicant: HONDA MOTOR CO., LTD., Tokyo (JP)

(72) Inventor: Hiroaki Kawasaki, Haga-gun (JP)

(21) Appl. No.: 14/535,857

(22) Filed: Nov. 7, 2014

(30) Foreign Application Priority Data
Nov. 7, 2013 (JP) 2013-231376

(51) Int. Cl. B60R 1/00; G02B 27/01

(52) U.S. Cl. CPC B60R 1/00; G02B 27/0101; G02B 2027/013; G02B 2027/0141; B60R 2300/205
USPC 345/7

(57) ABSTRACT

Disclosed is an information display device including: a projection portion that projects a projection image; and a cover portion that is driven to be changed between multiple states including a first state where the cover portion blocks at least part of an opening portion provided above a space that accommodates the projection portion and a second state where the cover portion is raised from the first state, in which when the projection portion performs projection in a state where the cover portion is controlled to be in the second state, a first image is projected onto a front window shield and a second image is projected onto the cover portion.

### CROSS REFERENCE TO RELATED APPLICATIONS

Priority is claimed on Japanese Patent Application No. 2013-231376, filed on Nov. 7, 2013, the contents of which are incorporated herein by reference.

### BACKGROUND OF THE INVENTION

1. Field of the Invention

The present invention relates to an information display device.

2. Description of Related Art

Research and development relating to an information display device capable of allowing a driver to recognize a variety of information such as a vehicle speed or a revolution speed of an engine without significantly averting the eyes of a driver of a vehicle from a front side of the vehicle have been performed. Such an information display device is able to prevent inattention to the front side caused as the driver visually checking meter panels.

In this regard, an information display device that displays two different information display images on a front glass and an exclusive partition board disposed under the front glass is known (Japanese Unexamined Patent Application, First Publication No. 2013-100032). Using such an information display device, the driver can acquire much information without noticeably averting their eyes from the front side of the vehicle.

### SUMMARY OF THE INVENTION

However, in the information display device of the related art, when displaying two pieces of different information with respect to the driver, since the exclusive partition board that partitions two pieces of information is used, the degree of freedom of design may be limited.

In order to solve the above-mentioned problems, an object of the invention is to provide an information display device capable of enhancing the degree of freedom of design.

In order to achieve the object relating to the above-mentioned problems, the invention employs the following aspects.

(1) According to an aspect of the invention, there is provided an information display device including: a projection portion that projects a projection image; and a cover portion that is driven to be changed between multiple states including a first state where the cover portion blocks at least part of an opening portion provided above a space that accommodates the projection portion and a second state where the cover portion is raised from the first state, in which when the projection portion performs projection in a state where the cover portion is controlled to be in the second state, a first image is projected onto a front window shield and a second image is projected onto the cover portion.

(2) In the information display device according to (1), the projection portion may project an image including the first image and the second image as one image, part of the one image projected onto the cover portion may form the second image, and part of the one image projected onto the front window shield without being interrupted by the cover portion may form the first image.

(3) In the information display device according to (1) or (2), a position where the first image is projected by the projection portion may be vertically above a position where the second image is projected by the projection portion, information relating to a traveling destination of a host vehicle may be displayed in the first image, and vehicle information indicating a state of the host vehicle may be displayed in the second image.

(4) In the information display device according to any one of (1) to (3), the projection portion may include: a concave mirror that is disposed on an optical path of projection light of the first image and reflects the projection light of the first image toward the opening portion, and a plane mirror that is disposed on an optical path of projection light of the second image and reflects the projection light of the second image toward the opening portion.

(5) In the information display device according to any one of (1) to (4), a surface of the cover portion onto which the second image is projected may be subjected to concave mirror treatment.

(6) The information display device according to any one of (1) to (5) may further include a control unit that controls the cover portion so that the cover portion is changed from the first state to the second state based on an operating state of the host vehicle.

(7) In the information display device according to any one of (1) to (6), a surface of the cover portion on a side where the second image is not projected may be formed and attached to be approximately continuous to a curved surface or a planar surface formed by a peripheral member of the opening portion when the cover portion is in the first state.

According to the aspect of (1), since the information display device is configured to include the cover portion that is driven to be changed between the multiple states including the first state where the cover portion blocks at least part of the opening portion provided above the space that accommodates the projection portion and the second state where the cover portion is raised from the first state, in which when the projection portion performs projection in a state where the cover portion is controlled to be in the second state, the first image is projected onto the front window shield and the second image is projected onto the cover portion, the degree of freedom in design can be enhanced.

In the case of (2), since the information display device is configured so that the portion of one image projected onto the cover portion forms the second image and the portion of the one image projected onto the front window shield without being interrupted by the cover portion forms the first image, it is not necessary that the information display device include multiple projection portions, and thus, the cost and size can be reduced.

In the case of (3), since the information display device is configured so that the information relating to the traveling destination of the host vehicle is displayed in the first image and the vehicle information indicating the state of the host vehicle is displayed in the second image, the information display device can provide an alarm indicating approach of another vehicle or the like and the vehicle information of the host vehicle to the driver.

In the case of (4), since the information display device is configured so that the projection portion includes the concave mirror that is disposed on the optical path of the projection light of the first image and reflects the projection light of the first image toward the opening portion and the plane mirror that is disposed on the optical path of the projection light of the second image and reflects the projection light of the second image toward the opening portion, a display image of the first image appears on a side distant from the driver, and a display image of the second image appears on a side near the driver. Thus, the information display device can display the information relating to the traveling destination of the host vehicle with a feeling of distance close to a scene in front of the vehicle and can display the host vehicle information indicating the state of the host vehicle with a feeling of distance close to a meter panel, and thus, the driver can pay attention to driving without a sense of discomfort.

According to (5), since the information display device is configured so that the surface of the cover portion onto which the second image is projected is subjected to the concave mirror treatment, the projection distance of the second image can be adjusted, and the display size of the second image can be changed based on the adjustment.

In the case of (6), since the information display device is configured to include the control unit that controls the cover portion to change the first state to the second state based on the operating state of the vehicle, it is possible to prevent direct sunlight from entering the information display device during parking or the like, and to enhance the dust resistance.

In the case of (7), since the information display device is configured so that the surface of the cover portion on the side where the second image is not projected is formed and attached to be approximately continuous to the curved surface or the planar surface formed by the peripheral member of the opening portion when the cover portion is in the first state, the information display device can prevent a poor appearance due to the existence of the opening portion.

### BRIEF DESCRIPTION OF THE DRAWINGS

FIG. 1 is a partial perspective view illustrating an example of a vehicle on which an information display device 20 according to an embodiment of the invention is mounted.

FIG. 2 is a diagram illustrating an arrangement example of a combiner 25 in a first state and peripheral members thereof.

FIG. 3 is a diagram illustrating an arrangement example of the combiner 25 in a second state and the peripheral members thereof.

FIG. 4 is a diagram illustrating an example of the periphery of a driver's seat 2 when seen from a visual line direction LV of a driver 3 shown in FIG. 1.

### DETAILED DESCRIPTION OF THE INVENTION

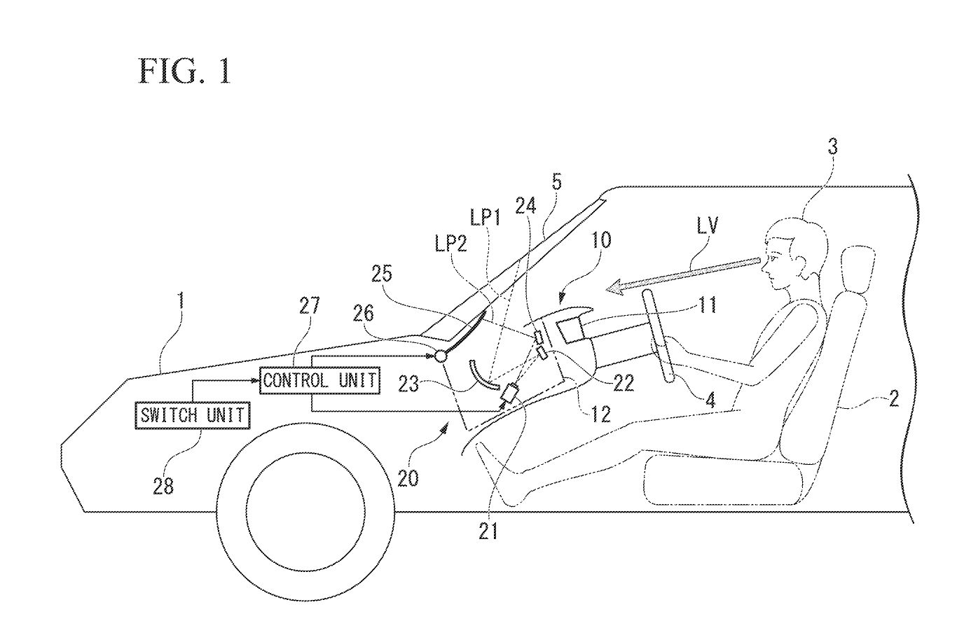

Hereinafter, embodiments of the invention will be described with reference to the accompanying drawings. FIG. 1 is a partial perspective view illustrating an example of a vehicle on which an information display device 20 according to an embodiment of the invention is mounted. Here, the vehicle refers to a four-wheeled automobile, but may be an automatic two-wheeled vehicle or other automobiles. As shown in FIG. 1, in the periphery of a driver's seat 2 of a vehicle 1, a steering wheel 4 operated by a driver 3 who is seated in the driver's seat 2, a front window shield 5, an instrument panel 10, a meter panel 11 provided in a front portion of the instrument panel 10, and the like are arranged.

Here, the front window shield 5 is formed of glass, for example, but may be formed of resin, plastic or the like. Further, the meter panel 11 is a panel on which instruments indicating a vehicle speed or a revolution speed of an engine of the vehicle 1, an operating state of a traffic indicator, and the like are provided.

The information display device 20 includes a projection portion 21, a first reflecting mirror 22, a second reflecting mirror 23, a third reflecting mirror 24, a combiner 25, a switching mechanism portion 26, a control unit 27, and a switch unit 28. The information display device 20 is accommodated in a concave portion 12 formed on an upper surface of the instrument panel 10 of the vehicle 1. Accordingly, the driver 3 who is seated in the driver's seat 2 hardly visually checks the inside of the concave portion 12. The projection portion 21 is a projector that includes a transmissive liquid crystal panel or a reflective liquid crystal display panel, or a digital mirror device (DMD) or the like, corresponding to each of red, green and blue (RGB) which are the three primary colors of light, and projects a projection image by light radiated from a light emitting diode (LED) light source, a laser light source, or the like.

The projection portion 21 projects a first image onto the front window shield 5, and projects a second image onto the combiner 25 (which will be described later). Details about information displayed in the first image and the second image will be described later. As shown in FIG. 1, the projection portion 21 is disposed in a backward and upward direction of the vehicle 1, and reflects part of the projected projection light in the order of the first reflecting mirror 22 and the second reflecting mirror 23, and projects the light toward the front window shield 5 as the first image. Further, the projection portion 21 reflects another part of the projected projection light by the third reflecting mirror 24, and projects the light toward the combiner 25 as the second image. The direction of the projection portion 21 may be set as a direction different from the backward and upward direction of the vehicle 1, for example, an upward direction or a forward direction of the vehicle 1, by increasing the number of reflecting mirrors or adjusting the directions of the reflecting mirrors.

The first reflecting mirror 22 reflects projection light LP1 projected by the projection portion 21 toward the second reflecting mirror 23. The first reflecting mirror 22 is a plane mirror, for example. Here, the projection light LP1 is projected onto the front window shield 5 as the first image. The second reflecting mirror 23 reflects the projection light LP1 projected by the projection portion 21 and reflected by the first reflecting mirror 22 toward the front window shield 5. The second reflecting mirror 23 is a concave mirror, for example. The third reflecting mirror 24 reflects projection light LP2 projected by the projection portion 21 toward the combiner 25. The third reflecting mirror 24 is a plane mirror, for example. Here, the projection light LP2 is projected onto the combiner 25 as the second image. The projection light projected by the projection portion 21 may be reflected to another reflecting mirror, after being reflected from these reflecting mirrors, to then be projected toward the front window shield 5 or the combiner 25.

The combiner (cover portion) 25 is provided in the instrument panel 10, and for example, is formed by a plate-like half mirror having a curved surface, a hologram element, or the like. Hereinafter, it is assumed that the combiner 25 is the plate-like half mirror having the curved surface. The combiner 25 is driven to be changed between multiple states including a first state where the combiner 25 blocks portion or the entirety of an opening portion 30 (to be described later) provided above the concave portion 12 that accommodates the projection portion 21 and a second state where the driver 3 can visually check the second image due to the projection light LP2, by the switching mechanism portion 26 and the control unit 27 (which will be described later).

The switching mechanism portion 26 includes an actuator that drives the combiner 25 to change the form of the combiner 25 between the first state and the second state based on a control signal from the control unit 27, a link mechanism for changing the states, and the like. The control unit 27 operates the actuator of the switching mechanism portion 26 to change the form of the combiner 25 between the first state and the second state. The control unit 27 receives an input from the switch unit 28 (to be described later) to operate the actuator of the switching mechanism portion 26. The switch unit 28 includes a variety of switches including an accessory (ACC) power switch and an ignition switch, for example.

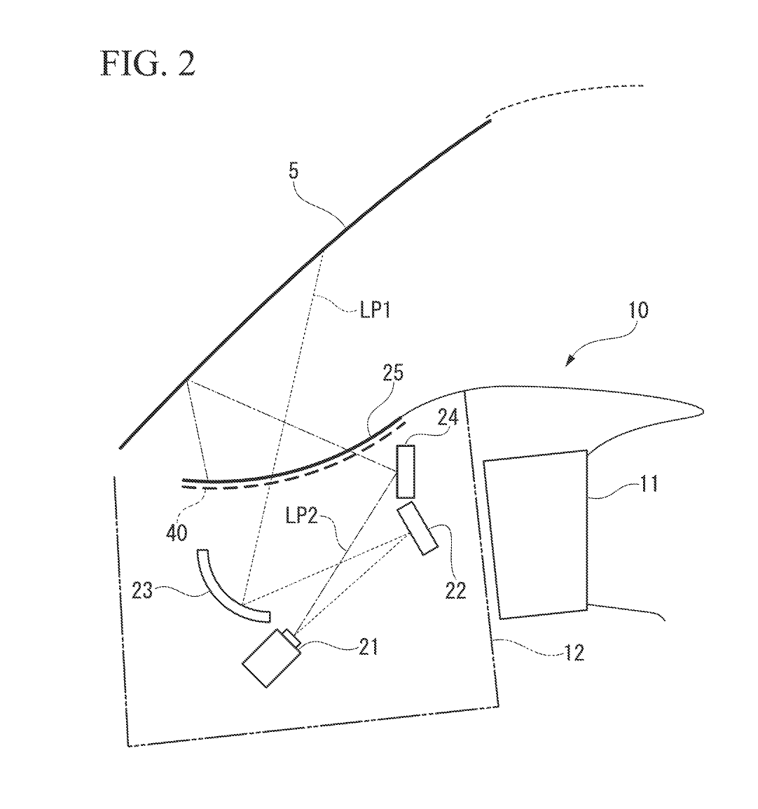

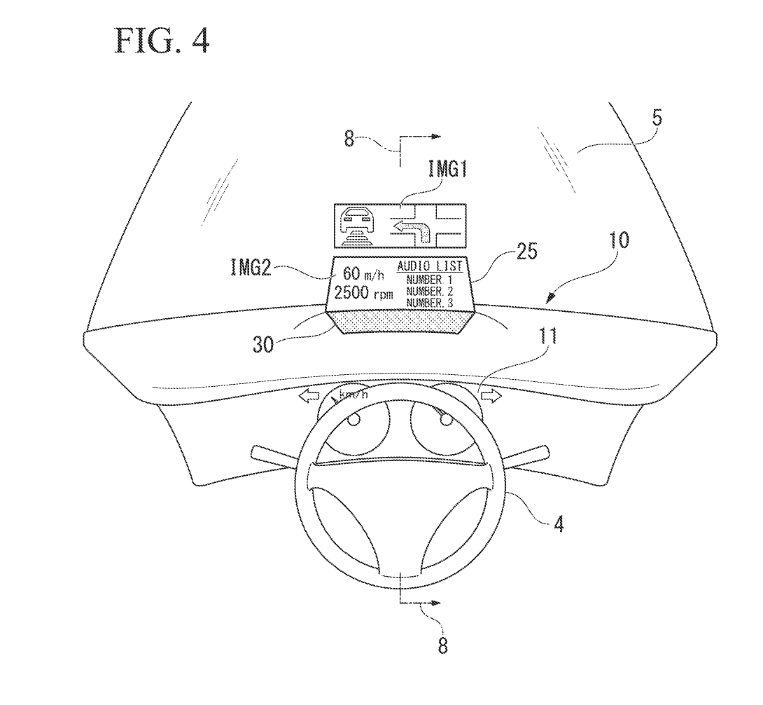

Here, the combiner 25 in the first state, and the opening portion 30 and the dustproof lens 40 will be described with reference to FIG. 2. FIG. 2 is a diagram illustrating an arrangement example of the combiner 25 in the first state and peripheral members thereof. FIG. 2 is an example of an enlarged cross-sectional view taken along line 8-8 in FIG. 4. In FIG. 2, the combiner 25 is in the first state, and blocks the opening portion 30 that serves as an entrance to the concave portion 12 formed on the upper surface of the instrument panel 10.

Further, the combiner 25 covers an upper surface of the dustproof lens 40 provided in the opening portion 30. The dustproof lens 40 is a lens configured to prevent dust or the like from entering the information display device 20 accommodated inside the concave portion 12, and is able to transmit the projection light LP1 and the projection light LP2. The dustproof lens 40 does not change an optical path of the projection light, but may change one or both the optical paths of the projection light LP1 and the projection light LP2 to enlarge, reduce or deform the projection image. Details about the dustproof lens 40 when the combiner 25 is in the second state will be described later.

Since the combiner 25 is the half mirror as described above, the combiner 25 transmits the projection light LP1 in the first state. Accordingly, since the dustproof lens 40 and the combiner 25 transmit the projection light LP1 even though the combiner 25 is in the first state, the first image is projected onto the front window shield 5. Further, the dustproof lens 40 and the combiner 25 also transmit the projection light LP2. When the transmitted light is reflected by the front window shield 5, the light is reflected in a direction different from a direction toward the eyes of the driver 3, and thus, a possibility that the second image is visually checked by the driver 3 is low.

A surface of the combiner 25 in the first state on a side where the second image is not projected (surface capable of being visually checked by the driver 3 when the combiner 25 is in the first state shown in FIG. 2) is formed and attached to be approximately continuous to a curved surface or a planar surface formed by a member of the instrument panel 10 in the vicinity of the opening portion 30 when the combiner 25 is in the first state. Thus, a configuration in which the instrument panel 10 is provided with the combiner 25 of the information display device 20 is obtained, and the combiner 25 and the instrument panel 10 are integrally formed when the vehicle is parked, for example. Thus, it is possible to enhance a design characteristic inside the vehicle when seen from the outside, compared with a case where the combiner 25 is regularly raised with respect to the instrument panel 10 or a case where a concave portion or a convex portion is generated in the instrument panel 10 due to the combiner when the combiner is closed, for example. Further, on the front surface of the combiner 25 in the first state capable of being visually checked in the visual line direction LV of the driver 3, for example, the same surface treatment as that of the instrument panel 10 may be performed to obtain a design with a high sense of unity.

As the driver 3 turns off the ACC power switch or the ignition switch of the vehicle included in the switch unit 28, the control unit 27 may change the form of the combiner 25 from a state different from the first state, including the second state, to the first state. Further, as the driver 3 may turn on the ACC power switch or the ignition switch of the vehicle included in the switch unit 28, the control unit 27 may change the form of the combiner 25 from a state different from the second state, including the first state, to the second state. In addition, the control unit 27 may change the form of the combiner 25 between the first state and the second state based on an input received from the driver 3 through a graphical user interface (GUI) or the like included in a car navigation system or the like.

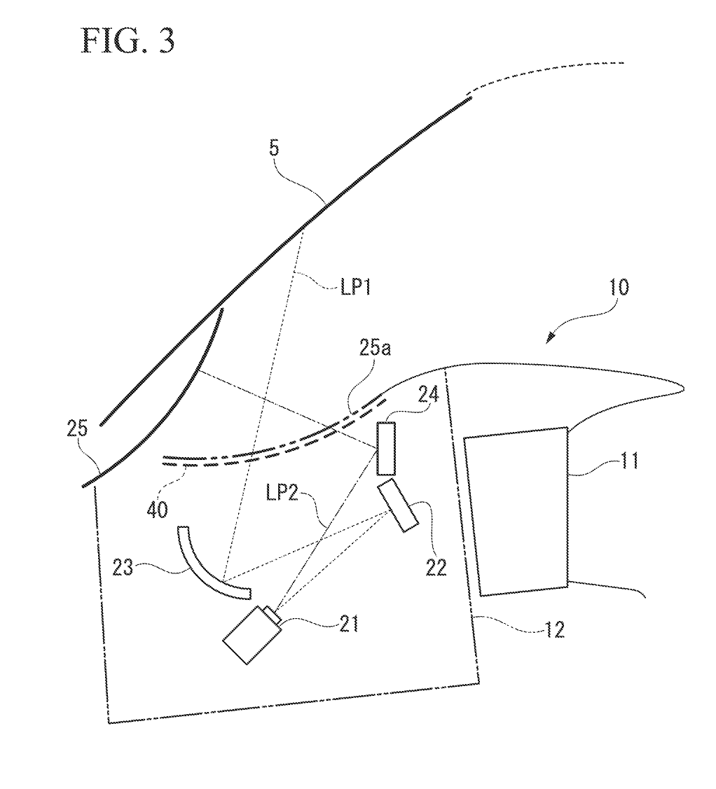

Next, the combiner 25 in the second state, the opening portion 30, and the dustproof lens 40 will be described with reference to FIG. 3. FIG. 3 is a diagram illustrating an arrangement example of the combiner 25 in the second state and the peripheral members thereof. FIG. 3 shows another example of the enlarged cross-sectional view taken along line 8-8 in FIG. 4. In FIG. 3, the combiner 25 is changed from a position 25a of the combiner 25 in the first state shown in FIG. 2 to a position in the second state by the control unit 27.

The dustproof lens 40 capable of transmitting the above-mentioned projection light LP1 and the projection light LP2 is provided in a portion (not shown) of the opening portion 30. The dustproof lens 40 provided in the opening portion 30 is not essential, and instead, any dustproof treatment different from the dustproof lens 40 may be used.

The shape of the dustproof lens 40 is formed, for example, as a curved surface such that light that is not transmitted but reflected, among light incident in a direction opposite to the direction where the projection portion 21 is disposed, is condensed to the combiner 25. The light incident in the direction opposite to the direction where the projection portion 21 is disposed includes ambient light including solar light or the like, for example. Further, the dustproof lens 40 is disposed at an angle where the condensed light is reflected by the combiner 25 in a direction different from the direction toward the eyes of passengers including the driver 3, for example. Using the shape and installation method of the dustproof lens 40 as configured above, the information display device 20 is able to prevent poor visual recognition of the driver 3 for the first image and the second image due to the ambient light such as solar light or the like.

As shown in FIG. 1 or FIG. 3, the combiner 25 in the second state is raised upward from the instrument panel 10. The front surface of the combiner 25 in the second state capable of being visually checked in the visual line direction LV of the driver 3 is subjected to concave mirror treatment, for example. Further, when receiving the projection light LP2 projected by the projection portion 21, the front surface of the combiner 25 in the second state capable of being visually checked in the visual line direction LV of the driver 3 changes the optical path of the projection light LP2. When the combiner 25 is formed by a hologram element, the front surface thereof subjected to the concave mirror treatment changes the optical path of the projection light LP2 by a diffraction phenomenon. The front surface of the combiner 25 subjected to the concave mirror treatment has a function of condensing the projection light LP2. Thus, it is possible to form a virtual image of the second image on a far front side compared with a case where the light is simply reflected. The far front side refers to a front side of about 1 meter, for example. The combiner 25 forms the virtual image of the second image at a position on the far front side and transmits light from the front side, to thereby allow the driver 3 to visually check both the virtual image and an outside view or the like that really exists in front of the vehicle.

FIG. 4 is a diagram illustrating an example of the periphery of the driver's seat 2 when seen in the visual line direction LV of the driver 3 shown in FIG. 1. The combiner 25 shown in FIG. 4 is in the above-described second state, and the opening portion 30 is exposed on the surface of the instrument panel 10 where the combiner 25 in the first state is disposed. As described above, in the opening portion 30, the transparent dustproof lens 40 is disposed to prevent dust from entering the concave portion 12 formed on the upper surface of the instrument panel 10 where the information display device 20 is disposed.

The projection portion 21 reflects the projection light LP1 from the first reflecting mirror 22 and the second reflecting mirror 23 to project a first image IMG1 onto the front window shield 5. Here, the first image is an image that represents information relating to a traveling destination of the host vehicle, for example. Specifically, the first image is an image that represents various alarms generated based on vehicle-to-vehicle communication, road-to-vehicle communication, pedestrian-to-vehicle communication or the like, map information provided by the car navigation system, or the like. In the first image IMG1 shown in FIG. 4, map information and route guiding information, preceding vehicle following information and the like from the car navigation system and an external input terminal are displayed as the information relating to the traveling destination of the vehicle.

Further, the projection portion 21 reflects the projection light LP2 from the third reflecting mirror 24 to project a second image IMG2 onto the combiner 25. Here, the second image is an image displayed as vehicle information indicating the state of the host vehicle, for example. Specifically, the second image is an image that represents part or all of a measurement value indicated by a speed meter or a tachometer of an engine, a fuel consumption meter, a supercharger meter, a negative pressure meter, a voltmeter, an oil pressure gauge, a water temperature gauge, an altimeter or the like, an alarm for warning the state of the vehicle 1, an operating state of a direction indicator, and the like. In the second image IMG2 shown in FIG. 4, a vehicle speed, a revolution speed of the engine and the like are displayed as the vehicle information. A list (for example, AUDIO LIST in FIG. 4) of a musical composition reproduced by a car audio of the host vehicle shown in FIG. 4, a program name of radio broadcasting, or the like may be displayed in the second image IMG2.

In this way, as the above-described vehicle information is displayed on the combiner 25 as the second image, the driver 3 can recognize the vehicle information by the second image IMG2 displayed on the combiner 25 even when part of the meter panel 11 is hidden by the steering wheel 4 or the like as shown in FIG. 4, for example.

The information displayed in the first image and the second image may be changed by the driver 3. Further, the information display device 20 may be mounted on a vehicle where the meter panel 11 is not provided, instead of being mounted on the vehicle 1 in which the meter panel 11 is disposed in the front portion of the instrument panel 10.

As described above, the information display device 20 according to the present embodiment is configured to include the combiner 25 that is driven to be changed between multiple states including the first state where the combiner 25 blocks at least part of the opening portion 30 provided above the concave portion 12 that accommodates the projection portion 21 and the second state where the combiner 25 is raised from the first state. When the projection portion 21 performs projection in a state where the combiner 25 is controlled to be in the second state, the first image is projected onto the front window shield 5, and the second image is projected onto the combiner 25. Thus, the degree of freedom in design can be enhanced.

Further, since the information display device 20 is configured so that part of one image projected onto the combiner 25 by the projection portion 21 forms the second image, and part of the one image projected onto the front window shield 5 without being interrupted by the combiner 25 by the projection portion 21 forms the first image, it is not necessary that the information display device 20 include multiple projection portions, therefore, the cost and size can be reduced.

In addition, since the information display device 20 is configured so that the information relating to the traveling destination of the host vehicle is displayed as the first image and the vehicle information indicating the state of the host vehicle is displayed as the second image, the information display device 20 can provide an alarm indicating approach of another vehicle or the like and the vehicle information of the host vehicle to the driver 3.

Furthermore, since the information display device 20 is configured so that the projection portion 21 includes the concave mirror that is arranged on the optical path of the projection light LP1 of the first image and reflects the projection light LP1 of the first image toward the opening portion 30, and the plane mirror that is arranged on the optical path of the projection light LP2 of the second image and reflects the projection light LP2 of the second image toward the opening portion 30, the display image of the first image appears on a side distant from the driver 3, and the display image of the second image appears on a near side from the driver 3. Therefore, the information display device 20 can display the information relating to the traveling destination of the host vehicle with a feeling of distance close to a scene in front of the vehicle and can display the host vehicle information indicating the state of the host vehicle with a feeling of distance close to the meter panel 11, therefore, the driver 3 can pay attention to the driving without a sense of discomfort.

Further, since the information display device 20 is configured so that the surface of the combiner 25 onto which the second image is projected is subjected to the concave mirror treatment, the projection distance of the second image can be adjusted, and the display size of the second image can be changed based on the adjustment.

In addition, since the information display device 20 is configured to include the control unit 27 that controls the combiner 25 so that the combiner 25 is changed from the first state to the second state based on the operating state of the vehicle 1, it is possible to prevent direct sunlight from entering the information display device during parking or the like, and to enhance the dust resistance.

Furthermore, since information display device 20 is configured so that the surface of the combiner 25 on the side where the second image is not projected is formed and attached to be approximately continuous to the curved surface or the planar surface formed by the peripheral member of the opening portion 30 when the combiner 25 is in the first state, it is possible to prevent a poor appearance due to the existence of the opening portion 30.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information display device comprising:
a projection portion that projects a projection image; and
a cover portion that is driven to be changed between multiple states including a first state where the cover portion blocks at least part of an opening portion provided above a space that accommodates the projection portion and a second state where the cover portion is raised from the first state,
wherein when the projection portion performs projection in a state where the cover portion is controlled to be in the second state, a first image is projected onto a front window shield and a second image is projected onto the cover portion.

2. The information display device according to claim 1,
wherein the projection portion projects an image including the first image and the second image as one image, part of the one image projected onto the cover portion forms the second image, and part of the one image projected onto the front window shield without being interrupted by the cover portion forms the first image.

3. The information display device according to claim 1,
wherein a position where the first image is projected by the projection portion is vertically above a position where the second image is projected by the projection portion,
information relating to a traveling destination of a host vehicle is displayed in the first image, and
vehicle information indicating a state of the host vehicle is displayed in the second image.

4. The information display device according to claim 1,
wherein the projection portion includes:
a concave mirror that is disposed on an optical path of projection light of the first image and reflects the projection light of the first image toward the opening portion, and
a plane mirror that is disposed on an optical path of projection light of the second image and reflects the projection light of the second image toward the opening portion.

5. The information display device according to claim 1,
wherein a surface of the cover portion onto which the second image is projected is subjected to concave mirror treatment.

6. The information display device according to claim 1, further comprising:
a control unit that controls the cover portion so that the cover portion is changed from the first state to the second state based on an operating state of the host vehicle.

7. The information display device according to claim 1,
wherein a surface of the cover portion on a side where the second image is not projected is formed and attached to be approximately continuous to a curved surface or a planar surface formed by a peripheral member of the opening portion when the cover portion is in the first state.
